(19) United States
(12) Patent Application Publication
(10) Pub. No.: US 2020/0022132 A1
(43) Pub. Date: Jan. 16, 2020

(54) APERIODIC CHANNEL STATE INFORMATION (CSI) AND CSI-REFERENCE SIGNAL (RS) RESOURCE POOLING

(71) Applicant: Telefonaktiebolaget LM Ericsson (publ), Stockholm (SE)

(72) Inventors: Stephen GRANT, Pleasanton, CA (US); Mattias FRENNE, Uppsala (SE)

(21) Appl. No.: 16/335,464

(22) PCT Filed: Sep. 29, 2017
(86) PCT No.: PCT/IB2017/056044

§ 371 Date: Mar. 21, 2019

Related U.S. Application Data
(60) Provisional application No. 62/403,035, filed on Sep. 30, 2016.

(51) Int. Cl. H04W 72/04; H04L 5/00; H04W 72/08

(52) U.S. Cl. CPC H04W 72/0413; H04W 72/082; H04L 5/0053; H04L 5/0051

(57) ABSTRACT

A method, wireless device and network node for configuring and using CSI-RS are disclosed. According to one embodiment, a method includes transmitting to a wireless device an indication of channel state information reference signals, CSI-RS, resources, the indication indicating one or more than one CSI-RS resources within a configured plurality of CSI-RS resources configured to be used by the wireless device for CSI signaling.

### TECHNICAL FIELD

This disclosure relates to wireless communication, and in particular to configuring channel state information-reference signal (CSI-RS) resources in a wireless communication system.

### BACKGROUND

In Third Generation Partnership Project (3GPP) Long Term Evolution (LTE) systems, data transmissions in both downlink, i.e. from a network node or base station such as an eNodeB (eNB) to a wireless device such as a user equipment (UE) and uplink. i.e., from a wireless device or wireless device to a network node or base station or eNB, are organized into radio frames of 10 ms, each radio frame consisting of ten equally-sized subframes of length Tsubframe=1 ms, as shown in FIG. 1.

LTE uses Orthogonal Frequency Division Multiplexing (OFDM) in the downlink and Single Carrier OFDM (SC-OFDM) in the uplink. The basic LTE downlink physical resource can thus be seen as a time-frequency grid as illustrated in FIG. 2 where each resource element corresponds to one OFDM subcarrier during one OFDM symbol interval.

Furthermore, the resource allocation in LTE is typically described in terms of resource blocks (RBs), where a resource block corresponds to one slot (0.5 ms) in the time domain and 12 contiguous subcarriers in the frequency domain. Resource blocks are numbered in the frequency domain, starting with 0 from one end of the system bandwidth.

Similarly, the LTE uplink resource grid is illustrated in FIG. 3, where N_{RB}^{UL} is the number of resource blocks (RB) contained in the uplink system bandwidth, N_{SC}^{RB} is the number of subcarriers in each RB, where typically, N_{SC}^{RB}=12, N_{symb}^{UL} is the number of SC-OFDM symbols in each slot, where N_{symb}^{UL}=7 for normal cyclic prefix (CP) and N_{symb}^{UL}=6 for extended CP. A subcarrier and a SC-OFDM symbol form an uplink (UL) resource element (RE).

Downlink data transmissions from a network node to a wireless device are dynamically scheduled, i.e., in each subframe the network node transmits control information about which terminal's data is transmitted and upon which resource blocks the data is transmitted, in the current downlink subframe. This control signaling is typically transmitted in the first 1, 2, 3 or 4 OFDM symbols in each subframe. A downlink system with 3 OFDM symbols as control is illustrated in FIG. 4.

Similar to downlink, uplink transmissions from a wireless device to a network node are also dynamically scheduled through the downlink control channel. When a wireless device receives an uplink grant in subframe n, it transmits data in the uplink at subframe n+k, where k=4 for frequency division duplex (FDD) system and k varies for TDD systems.

In LTE, a number of physical channels are supported for data transmissions. A downlink or an uplink physical channel corresponds to a set of resource elements carrying information originating from higher layers while a downlink or an uplink physical signal is used by the physical layer but does not carry information originating from higher layers.

Some of the downlink physical channels and signals supported in LTE are:

Physical Downlink Shared Channel (PDSCH)

Physical Downlink Control Channel (PDCCH)

Enhanced Physical Downlink Control Channel (EPDCCH)

Reference signals:
Cell Specific Reference Signals (CRS)
Demodulation Reference Signal for PDSCH
Channel State Information Reference Signals (CSI-RS)
   PDSCH is used mainly for carrying user traffic data and higher layer messages in the downlink and is transmitted in a DL subframe outside of the control region as shown in FIG. 4. Both PDCCH and EPDCCH are used to carry Downlink Control Information (DCI) such as PRB allocation, modulation level and coding scheme (MCS), precoder used at the transmitter, and etc. PDCCH is transmitted in the first one to four OFDM symbols in a DL subframe, i.e. the control region, while EPDCCH is transmitted in the same region as PDSCH.

Some of the uplink physical channels and signals supported in LTE are:

Physical Uplink Shared Channel (PUSCH)

Physical Uplink Control Channel (PUCCH)

Demodulation Reference Signal (DMRS) for PUSCH

Demodulation Reference Signal (DMRS) for PUCCH

The PUSCH is used to carry uplink data from the wireless device to the network node. The PUCCH is used to carry uplink control information from the wireless device to the network node.

In the 3GPP RAN1#86 standardization meeting an agreement on aperiodic CSI reporting for NR was made to study aperiodic CSI reporting in conjunction with aperiodic RS transmission. In particular, it was agreed to study dynamic indication of aperiodic RS and interference measurement resource including Resource pool sharing for aperiodic channel and interference measurement resources.

Solutions for resource pool sharing for aperiodic channel and interference measurement resources are therefore still needed.

### SUMMARY

A method, wireless device and network node for configuring and using CSI-RS are disclosed. According to one embodiment, a method includes transmitting to a wireless device an indication of channel state information reference signals, CSI-RS, resources, the indication indicating one or more than one CSI-RS resources within a configured plurality of CSI-RS resources configured to be used by the wireless device for CSI signaling.

In some embodiments, a method at a network node is provided, the method including transmitting to a wireless device an indication of channel state information reference signals, CSI-RS, resources, the indication indicating one or more than one CSI-RS resources within a configured plurality of CSI-RS resources configured to be used by the wireless device for CSI signaling.

In some embodiments, the plurality of CSI-RS resources configured to be used by the wireless device for CSI signaling are configured through higher layers. In some embodiments, the indication is transmitted dynamically. In some embodiments, the indication is transmitted with one of downlink control information, DCI, and Medium Access Control Control Element, MAC CE signaling. In some embodiments, the indication indicates two temporally-successive orthogonal frequency division multiplex, OFDM, symbols, each of the two temporally-successive OFDM symbols being associated with at least one of two ports to form a resource element. In some embodiments, the indication indicates two successive frequency units forming one orthogonal frequency division multiplex, OFDM, symbol, each of the two frequency units being associated with at least one of two ports to form a resource element. In some embodiments, multiple different indications of different aggregations of resource elements are configured for the wireless device. In some embodiments, at least two different aggregations of resource elements share at least a pair of CSI-RS resources in common. In some embodiments, a number of resources sets are configured from a pool of N CSI-RS resources. In some embodiments, a report setting is based on resource settings applicable to a set of CSI-RS resources.

In some embodiments, a network node is provided and includes a transceiver configured to transmit to a wireless device an indication of channel state information reference signals, CSI-RS, resources, the indication indicating one or more than one CSI-RS resource within a configured plurality of CSI-RS resources configured to be used by the wireless device for CSI signaling.

In some embodiments, the plurality of CSI-RS resources configured to be used by the wireless device for CSI signaling are configured through higher layers. In some embodiments, the indication is transmitted dynamically. In some embodiments, the indication is transmitted with one of downlink control information, DCI, and Medium Access Control Control Element, MAC CE signaling. In some embodiments, the indication indicates two temporally-successive orthogonal frequency division multiplex, OFDM, symbols, each of the two temporally-successive OFDM symbols being associated with at least one of two ports to form a resource element. In some embodiments, the indication indicates two successive frequency units forming one orthogonal frequency division multiplex, OFDM, symbol, each of the two frequency units being associated with at least one of two ports to form a resource element. In some embodiments, multiple different indications of different aggregations of resource elements are configured for the wireless device. In some embodiments, at least two different aggregations of resource elements share at least a pair of CSI-RS resources in common. In some embodiments, a number of resources set is configured from a pool of N CSI-RS resources. In some embodiments, a report setting is based on resource settings applicable to a set of CSI-RS resources.

In some embodiments, a network node is provided and includes a transceiver module configured to transmit to a wireless device an indication of channel state information reference signals, CSI-RS, resources, the indication indicating one or more than one CSI-RS resource within a configured plurality of CSI-RS resources configured to be used by the wireless device for CSI signaling.

In some embodiments, a method at a network node of configuring channel state information reference signals, CSI-RS, is provided. The method includes determining a set of CSI-RS resource elements, the set comprising at least two CSI-RS resources. The method also includes aggregating a plurality of CSI-RS resource elements into resources within a resource pool.

In some embodiments, the plurality of CSI-RS resource elements configured to be used by the wireless device for CSI signaling has been configured through higher layers. In some embodiments, the method further includes indicating an aggregation of CSI-RS resource elements to a wireless device. In some embodiments, the indicating is by dynamic signaling. In some embodiments, the indicating is by downlink control information, DCI. In some embodiments, the set of CSI-RS resource elements support a plurality of wireless devices for cell-specific beam sweep whereby the wireless devices measure a same beam. In some embodiments, different sets of CSI-RS resource elements are indicated to different wireless devices to enable each of the different wireless devices to measure a channel on a different beam.

In some embodiments, a network node for configuring channel state information reference signals, CSI-RS, is provided. The network node includes processing circuitry configured to: determine a set of CSI-RS resource elements, the set comprising at least two CSI-RS resources; and aggregate a plurality of CSI-RS resource elements into resources within a resource pool.

In some embodiments, the plurality of CSI-RS resource elements configured to be used by the wireless device for CSI signaling have been configured through higher layers. In some embodiments, the processing circuitry is further configured to indicate an aggregation of CSI-RS resource elements to a wireless device. In some embodiments, the indicating is by dynamic signaling. In some embodiments, the indicating is by downlink control information, DCI. In some embodiments, the set of CSI-RS elements support a plurality of wireless devices for cell-specific beam sweep whereby the wireless devices measure a same beam. In some embodiments, different sets of CSI-RS resource elements are indicated to different wireless devices to enable each of the different wireless devices to measure a channel on a different beam.

In some embodiments, a network node for configuring channel state information reference signals, CSI-RS. The network node includes a CSI-RS resource pool determination module configured to determine a set of CSI-RS resource elements, the set comprising at least two CSI-RS resources. The network node also includes an aggregation module configured to aggregate a plurality of CSI-RS resource elements into resources within a resource pool.

In some embodiments, a method at a wireless device includes receiving an indication of channel state information reference signals, CSI-RS, resources, the indication indicating at one or more than one CSI-RS resources within a configured plurality of CSI-RS resources configured to be used by the wireless device for CSI signaling. The method also includes performing CSI signaling on the at least one CSI resources.

In some embodiments, the indication indicates two temporally-successive orthogonal frequency division multiplex, OFDM, symbols, each of the two temporally-successive OFDM symbols being associated with at least one of two ports to form a resource element. In some embodiments, the indication indicates two successive frequency units forming one orthogonal frequency division multiplex, OFDM, symbol, each of the two frequency units being associated with at least one of two ports to form a resource element.

In some embodiments, a wireless device includes a transceiver configured to receive an indication of channel state information reference signals, CSI-RS, resources, the indication indicating one or more than one CSI-RS resources within a configured plurality of CSI-RS resources configured to be used by the wireless device for CSI signaling, and perform CSI signaling on the at least one CSI resources.

In some embodiments, the indication indicates two temporally-successive orthogonal frequency division multiplex, OFDM, symbols, each of the two temporally-successive OFDM symbols being associated with at least one of two ports to form a resource element. In some embodiments, the indication indicates two successive frequency units forming one orthogonal frequency division multiplex, OFDM, symbol, each of the two frequency units being associated with at least one of two ports to form a resource element.

In some embodiments, a wireless device includes a transceiver module configured to receive an indication of channel state information reference signals, CSI-RS, resources, the indication indicating one or more than one CSI-RS resources within a configured plurality of CSI-RS resources configured to be used by the wireless device for CSI signaling. The transceiver is configured to perform CSI signaling on the at least one CSI resources.

In some embodiments, a method at a base station includes transmitting to a user equipment an indication of channel state information reference signals, CSI-RS, resources, the indication indicating one or more than one CSI-RS resources within a configured plurality of CSI-RS resources configured to be used by the user equipment for CSI signaling.

In some embodiments, a base station comprises a transceiver configured to transmit to a user equipment an indication of channel state information reference signals, CSI-RS, resources, the indication indicating one or more than one CSI-RS resources within a configured plurality of CSI-RS resources configured to be used by the user equipment for CSI signaling.

In some embodiments, a method at a base station of configuring channel state information reference signals, CSI-RS. The method includes determining a set of CSI-RS resource elements, the set comprising at least two CSI-RS resources. The method also includes aggregating a plurality of CSI-RS resource elements into resources within a resource pool.

In some embodiments, a base station for configuring channel state information reference signals, CSI-RS. The base station includes processing circuitry configured to determine a set of CSI-RS resource elements, the set comprising at least two CSI-RS resources, and aggregate a plurality of CSI-RS resource elements into resources within a resource pool.

In some embodiments, a method at a user equipment includes receiving an indication of channel state information reference signals, CSI-RS, resources, the indication indicating one or more than one CSI-RS resources within a configured plurality of CSI-RS resources configured to be used by the user equipment for CSI signaling. The method includes performing CSI signaling on the at least one CSI resources.

In some embodiments, a user equipment includes a transceiver configured to receive an indication of channel state information reference signals, CSI-RS, resources, the indication indicating one or more than one CSI-RS resources within a configured plurality of CSI-RS resources configured to be used by the user equipment for CSI signaling, and to perform CSI signaling on the at least one CSI resources.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is an illustration of a radio frame;

FIG. 2 is an illustration of a time frequency grid;

FIG. 3 is an illustration of an uplink resource grid;

FIG. 4 illustrates a downlink configuration with 3 OFDM;

FIG. 5 shows two examples of configuring CSI-RS elements;

FIG. 6 shows a pool containing CSI-RS elements at least some of which may be shared by wireless devices;

FIG. 7 is a block diagram of a wireless communication system constructed according to principles set forth herein;

FIG. 8 is a block diagram of a network node constructed in accordance with principles set forth herein;

FIG. 9 is a block diagram of an alternative embodiment of the network node that can be implemented at least in part by software stored in memory and executable by a processor;

FIG. 10 is a block diagram of a wireless device configured to receive indications of CSI-RS resources and perform CSI signaling;

FIG. 11 is a block diagram of an alternative embodiment of the network node that can be implemented at least in part by software stored in memory and executable by a processor;

FIG. 12 is a flowchart of an exemplary process for providing an indication of CSI-RS resources to a wireless device;

FIG. 13 is a flowchart of an exemplary process for determining CSI-RS resource elements; and

FIG. 14 is a flowchart of an exemplary process at a wireless device of receiving CSI-RS resource indications.

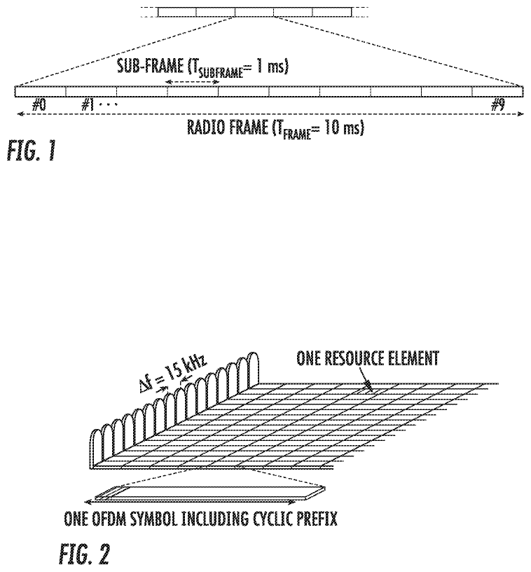

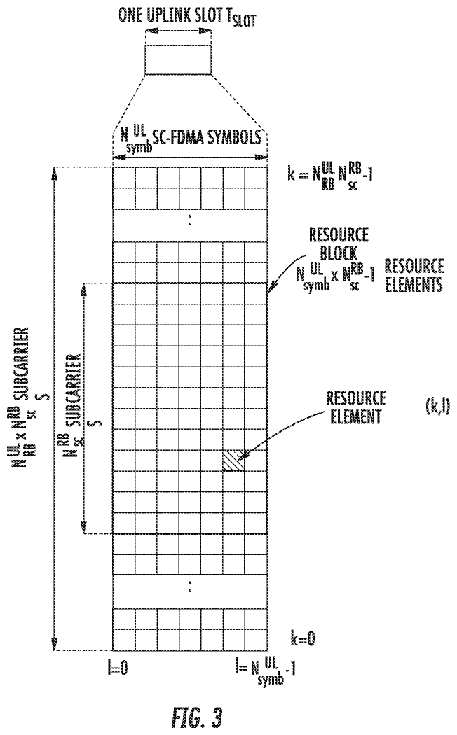

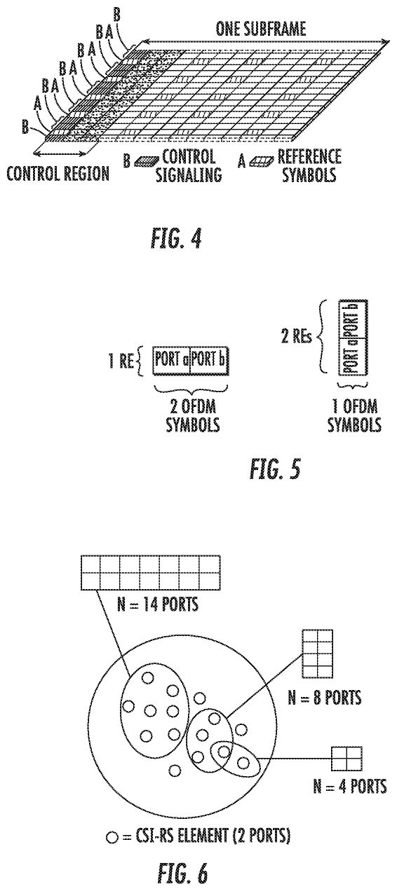

### DETAIL DESCRIPTION

Note that although terminology from the third generation partnership project (3GPP), i.e., long term evolution (LTE) is used in this disclosure to as an example, this should not be seen as limiting the scope of the disclosure to only the aforementioned system. Other wireless systems, including NR (i.e., 5G), wideband code division multiple access (WCDMA), WiMax, ultra mobile broadband (UMB) and global system for mobile communications (GSM), may also benefit from exploiting the concepts and methods covered within this disclosure.

Also note that terminology such as eNodeB and wireless device should be considered non-limiting and does in particular not imply a certain hierarchical relation between the two; in general “eNodeB” could be considered as device 1 and “wireless device” device 2, and these two devices communicate with each other over some radio channel. Also, while the disclosure focuses on wireless transmissions in the downlink, but embodiments are equally applicable in the uplink.

The term wireless device used herein may refer to any type of wireless device communicating with a network node and/or with another wireless device in a cellular or mobile communication system. Examples of a wireless device are user equipment (UE), target device, device to device (D2D) wireless device, machine type wireless device or wireless device capable of machine to machine (M2M) communication, PDA, iPAD, Tablet, mobile terminals, smart phone, laptop embedded equipped (LEE), laptop mounted equipment (LME), USB dongles etc.

The term “network node” used herein may refer to a radio network node or another network node, e.g., a core network node, MSC, MME, O&M, OSS, SON, positioning node (e.g. E-SMLC), MDT node, etc.

The term “network node” or “radio network node” used herein can be any kind of network node comprised in a radio network which may further comprise any of base station (BS), radio base station, base transceiver station (BTS), base station controller (BSC), radio network controller (RNC), evolved Node B (eNB or eNodeB), Node B, multi-standard radio (MSR) radio node such as MSR BS, relay node, donor node controlling relay, radio access point (AP), transmission points, transmission nodes, Remote Radio Unit (RRU) Remote Radio Head (RRH), nodes in distributed antenna system (DAS) etc.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Before describing in detail exemplary embodiments, it is noted that the embodiments reside primarily in combinations of apparatus elements and processing steps related to creating a reference signal sequence at a reduced peak to average ratio. Accordingly, elements have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

Certain embodiments of the present disclosure focus on the following aspect of a RAN #1 86 agreement: resource pool sharing for aperiodic channel and interference measurement resources.

One or more embodiments of the disclosure relate to aggregating CSI-RS elements in time and frequency. In particular, prior art uses broadband radio service (BRS) for beam sweep (a different RS) and CSI-RS for link adaptation, while certain embodiments of this disclosure use the same signals for both CSI-RS elements since there is flexibility to map CSI-RS elements in different dimensions. One or more embodiments of the disclosure relates to the definition of 1-port CSI-RS elements. In particular, a 2-port element definition may still be used, but transmit using only 1 port with 3 dB more power (since only one port is used).

R1-1609761, “Details on the unified CSI feedback framework for NR,” Ericsson, RAN1#86bis, October 2016, incorporated here by reference, proposes a CSI framework for New Radio (NR) that can be used to support the same basic functions as those supported in LTE for Class A and Class B-type operation, but in a unified way. The proposed framework can also support additional functions needed for NR, namely CSI-RS based beam management and hybrid analog/digital beamforming.

In this unified framework, each wireless device is configured to perform measurements based on an N-port CSI-RS configuration. How the wireless device shall perform these measurements is governed by a set of “rules” based on the value of N, the number of ports C in a unified codebook, and the selected rank R. Each rule corresponds to a different use case, e.g., Class A-type operation, Class-B, K=1, Class-B, K>1, etc.

Since the N-port CSI-RS configuration can be wireless device-specific, the CSI-RS overhead may become large if the number of simultaneously active users is large. The same issue occurs in LTE for Class B operation which has triggered study of overhead reduction approaches. One such approach is based on the combination of aperiodic CSI-RS transmission coupled with pooling of CS-RS resources. Within 3GPP, an agreement was achieved to support this approach for LTE Rel-14 (see, R1-168046, “WF on Aperiodic CSI-RS for Rel.14,” RAN1#86, August 2016.), incorporated here by reference.

In LTE, in a first step, users are pre-configured through higher layers a pool of CSI-RS resources which can be used for measurements. This pool is generic in the sense that these resources can subsequently be used to perform measurements in any beam and for any wireless device, hence the term “pool”. In a second step, a subset of the resources from the pool is activated/released dynamically to a given wireless device through either downlink control information (DCI) or medium access control element (MAC CE) signaling. Finally, in a third step, one out of the subset of resources is dynamically indicated to the wireless device through DCI signaling. The selected resource is then used for CSI measurement and reporting. With this approach, resources within the pool can be dynamically shifted and shared amongst users while avoiding frequent RRC reconfigurations since it is only in the first step the higher layer signaling is used.

An approach as described above may be adopted in NR for managing CSI-RS overhead and for supporting beam management in an efficient manner. Aiming to support both goals, some generalization of the LTE agreed procedure is necessary. Rather than restricting the wireless device to measure and report CSI on only one out of the subset of CSI-RS resources in the third step mentioned above, certain embodiments herein enable measurement and/or reporting on 2 or more resources as well. This functionality may be useful, for example, in beam management where a wireless device needs to measure signal strength on multiple beams, e.g., in a beam sweep operation. The intermediate second step may not be necessary; dynamic indication of the subset of resources on which the wireless device measures can be done dynamically in a single step. Thus, it is proposed to eliminate the intermediate second step in some embodiments.

Accordingly, some embodiments disclose aperiodic CSI reporting combined with resource pooling as agreed for LTE, yet generalized to support aperiodic measurement/reporting on one or more resources. In some further embodiments, the approach is simplified by removing the intermediate activation/release mechanism such that the one or more resources are dynamically configured in a single step.

In some embodiments that extend the unified CSI-RS framework noted above, an N-port CSI-RS configuration is associated with a certain CSI-RS configuration for each user (N need not be the same for all users and users may have multiple CSI-RS configurations, e.g., one for semi-persistent reporting and one for aperiodic reporting). Using the pooling framework, the resources for each user's CSI-RS configuration are selected from the pool of resources.

To allow flexible CSI-RS pooling, in some embodiments the CSI-RS configurations are modularized such that each N-port configuration is built from a number of smaller CSI-RS units. Those units are referred to as “CSI-RS elements,” to draw an analogy with control channel elements (CCEs) in LTE. In this way, the pool consists of a number of CSI-RS elements from which each CSI-RS configuration is built by aggregation. For flexibility in supporting different use cases, different configurations may share one or more CSI-RS elements.

FIG. 5 shows two possibilities for the basic CSI-RS element from which an N-port CSI-RS configurations is built. As can be seen, the 2 ports can be multiplexed in either time (left) or frequency (right). In one example of FIG. 5, a resource element includes two temporally-successive orthogonal frequency division multiplex, OFDM, symbols, each of the two temporally-successive OFDM symbols being associated with at least one of two ports. In the second example of FIG. 5, a resource element includes two successive frequency units forming one orthogonal frequency division multiplex, OFDM, symbol, each of the two frequency units being associated with at least one of two ports.

FIG. 6 shows a pool containing several of these CSI-RS elements. Various examples are shown on how to build different size CSI-RS configurations from these elements. One of the examples shows that CSI-RS elements may be shared between different CSI-RS configurations; the configurations built from the pool need not have mutually exclusive sets of elements. The formation of 3 different N-port CSI-RS configurations is illustrated. A first configuration is an aggregation of 7 CSI-RS elements (N=14 ports). A second configuration is an aggregation of 4 CSI-RS elements (N=8 ports). A third configuration is an aggregation of 2 CSI-RS elements (N=4 ports), where one of the elements is shared with the second configuration. Thus, multiple different aggregations of CSI-RS resource elements may be configured for a wireless device. Also, at least two different aggregations may share at least one CSI-RS resource element in common. In the examples of FIGS. 5 and 6, for an N-port CSI-RS configuration, a number of resource elements is equal to N divided by 2.

In one embodiments, the following steps may be used as a basis for a scalable design supporting N=2*n CSI-RS ports where n=1, 2, 3, 4, . . . : Constructing the CSI-RS resource pool from a number of basic 2-port CSI-RS elements. Arbitrary size N-port CSI-RS configurations are built by aggregation of N/2 elements.

The pooling concept described herein is beneficial for CSI-RS-based beam management in addition to being a general approach for managing CSI-RS overhead. To support beam management, an N-port CSI-RS configuration is formed using N/2 CSI-RS elements from the pool. In this case, the various CSI-RS elements correspond to different beams, e.g., in a beam sweep operation. wireless devices are then aperiodically triggered in a dynamic fashion to measure and report beam selection(s). This method supports both a “cell-specific” beam sweep, where multiple wireless devices measure the same beam, or a wireless device-specific beam sweep, e.g., for beam refinement. In the former case, all wireless devices share the same N-port CSI-RS configuration. In the latter, different wireless devices use different N-port CSI-RS configurations. By combining pooling with aperiodic CSI measurement, efficient beam management is achieved without resorting to “always-on” beam reference signals.

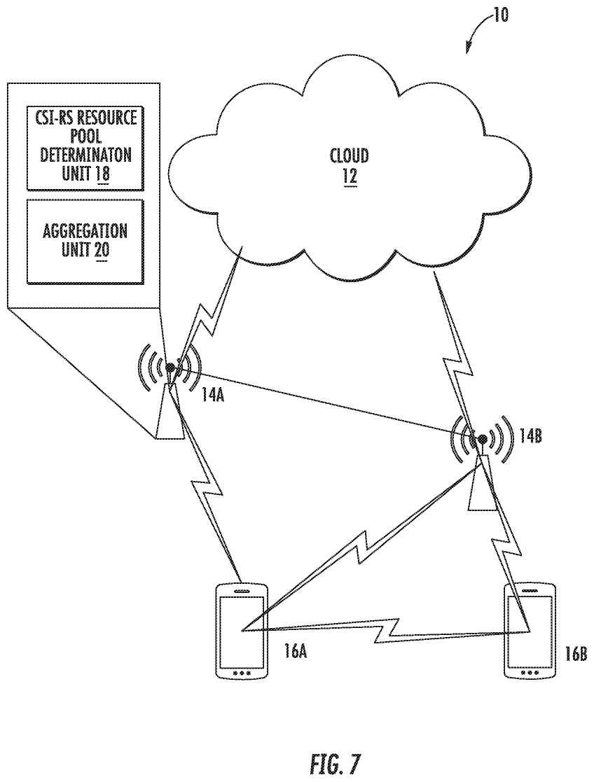

FIG. 7 is a block diagram of a wireless communication system 10 constructed according to principles set forth herein. The wireless communication network 10 includes a cloud 12. The wireless communication network 10 includes one or more network nodes 14A and 14B. The network nodes 14 may serve wireless devices 16A and 16B, referred to collectively herein as wireless devices 16. Note that, although only two wireless devices 16 and two network nodes 14 are shown for convenience, the wireless communication network 10 may typically include many more wireless devices (WDs) 16 and network nodes 14. A network node 14 includes a CSI-RS resource pool determination unit 18 configured to determine a set of CSI-RS elements the set comprising at least two CSI-RS resources. The network node 14 also includes an aggregation module configured to aggregate a plurality of CSI-RS elements into resources within a resource pool.

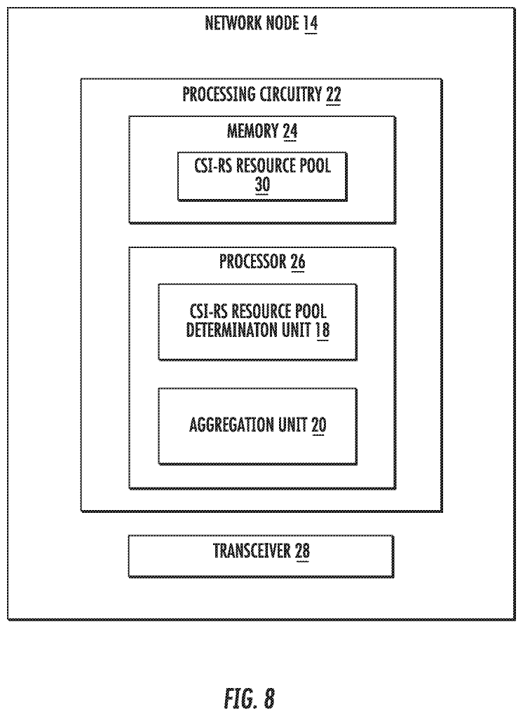

FIG. 8 is a block diagram of a network node 14 constructed in accordance with principles set forth herein. The network node 14 has processing circuitry 22. In some embodiments, the processing circuitry may include a memory 24 and processor 26. The processing circuitry may be configured to perform the one or more functions described herein. In addition to a traditional processor and memory, processing circuitry 22 may comprise integrated circuitry for processing and/or control, e.g., one or more processors and/or processor cores and/or FPGAs (Field Programmable Gate Array) and/or ASICs (Application Specific Integrated Circuitry).

Processing circuitry 22 may include and/or be connected to and/or be configured for accessing (e.g., writing to and/or reading from) memory 24, which may include any kind of volatile and/or non-volatile memory, e.g., cache and/or buffer memory and/or RAM (Random Access Memory) and/or ROM (Read-Only Memory) and/or optical memory and/or EPROM (Erasable Programmable Read-Only Memory). Such memory 24 may be configured to store code executable by control circuitry and/or other data, e.g., data pertaining to communication, e.g., configuration and/or address data of nodes, etc. Processing circuitry 22 may be configured to control any of the methods described herein and/or to cause such methods to be performed, e.g., by processor 26. Corresponding instructions may be stored in the memory 24, which may be readable and/or readably connected to the processing circuitry 22. In other words, processing circuitry 22 may include a controller, which may comprise a microprocessor and/or microcontroller and/or FPGA (Field-Programmable Gate Array) device and/or ASIC (Application Specific Integrated Circuit) device. It may be considered that processing circuitry 22 includes or may be connected or connectable to memory, which may be configured to be accessible for reading and/or writing by the controller and/or processing circuitry 22.

The memory 24 may be configured to store a pool of CSI-RS resource elements which, in some embodiments, may be grouped in pairs of two resources to form a resource element as shown in FIG. 5. The processor may include a CSI-RS resource pool determination unit 18 that is configured to determine a set of CSI-RS elements, the set comprising at least two CSI-RS resources. The processor 26 may also include an aggregation unit 20 configured to aggregate a plurality of CSI-RS elements into resources within a resource pool. The transceiver 28 may, in some embodiments, be configured to transmit to a wireless device 16 an indication of CSI-RS resources, the indication indicating one or more than one CSI-RS resources within a configured plurality of CSI-RS resources configured to be used by the wireless device 16 for CSI signaling.

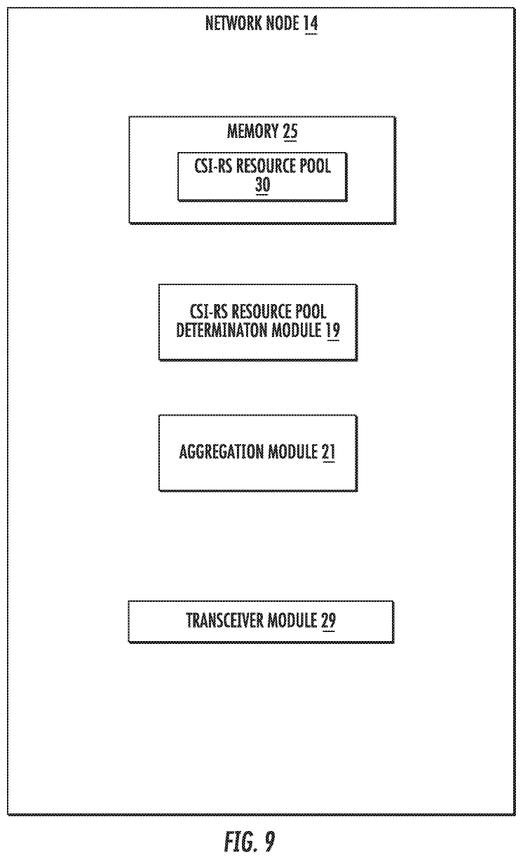

FIG. 9 is a block diagram of an alternative embodiment of the network node 14 that can be implemented at least in part by software stored in memory and executable by a processor. A memory module 25 is configured to store a CSI-RS resource pool 30. A CSI-RS resource pool determination module 19 is configured to determine a set of CSI-RS elements, the set comprising at least two CSI-RS resources. An aggregation module 21 is configured to aggregate a plurality of CSI-RS elements into resources within a resource pool. The transceiver module 29 is, in some embodiments, configured to transmit to a wireless device 16 an indication of CSI-RS resources, the indication indicating one or more than one CSI-RS resources within a configured plurality of CSI-RS resources configured to be used by the wireless device 16 for CSI signaling.

In some embodiments, the network node 14 configures a pool of CSI-RS resource elements to be used by at least one wireless device 16 for aperiodic reporting of channel state information (CSI). The network node 14 indicates at least one aggregation of CSI-RS resource elements of the pool of CSI-RS resources, at least one of the at least one aggregation of the CSI-RS resource elements being usable by the wireless device 16 to report channel state information to the network node 14. In some embodiments, the indication is transmitted to the wireless device 16 using downlink control information (DCI).

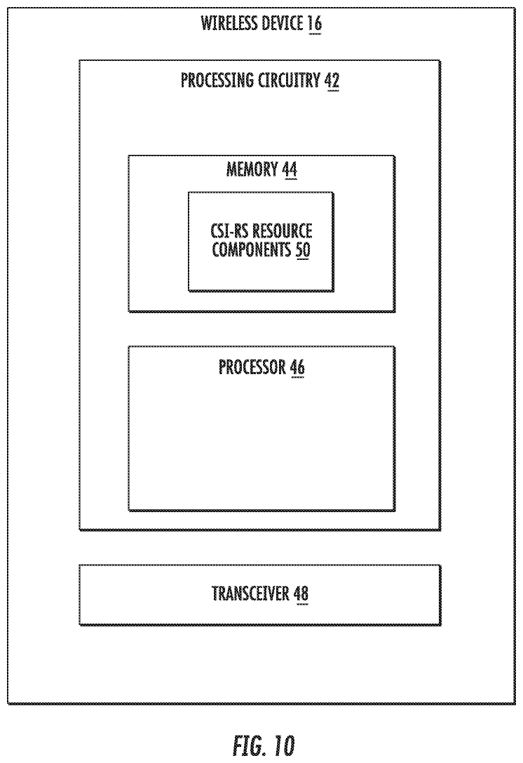

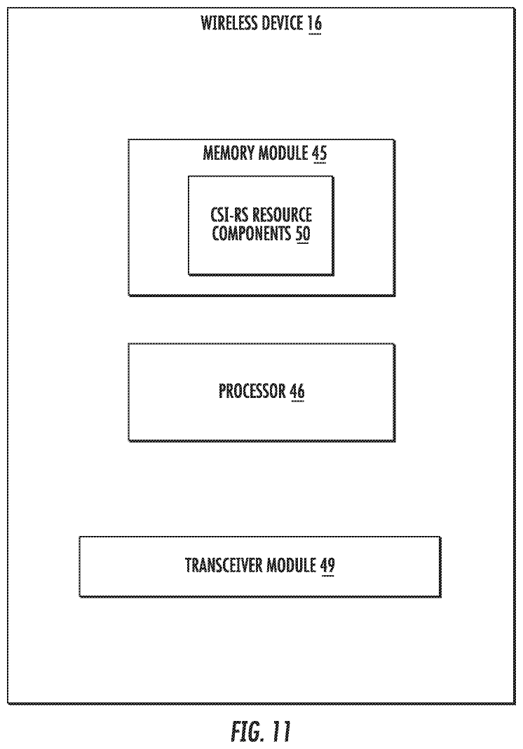

FIG. 10 is a block diagram of a wireless device 16 configured to receive indications of CSI-RS resources and perform CSI signaling. The wireless device 16 has processing circuitry 42. In some embodiments, the processing circuitry may include a memory 44 and processor 46, the memory 44 containing instructions which, when executed by the processor 46, configure processor 46 to perform the one or more functions described herein. In addition to a traditional processor and memory, processing circuitry 42 may comprise integrated circuitry for processing and/or control, e.g., one or more processors and/or processor cores and/or FPGAs (Field Programmable Gate Array) and/or ASICs (Application Specific Integrated Circuitry).

Processing circuitry 42 may include and/or be connected to and/or be configured for accessing (e.g., writing to and/or reading from) memory 44, which may include any kind of volatile and/or non-volatile memory, e.g., cache and/or buffer memory and/or RAM (Random Access Memory) and/or ROM (Read-Only Memory) and/or optical memory and/or EPROM (Erasable Programmable Read-Only Memory). Such memory 44 may be configured to store code executable by control circuitry and/or other data, e.g., data pertaining to communication, e.g., configuration and/or address data of nodes, etc. Processing circuitry 42 may be configured to control any of the methods described herein and/or to cause such methods to be performed, e.g., by processor 46. Corresponding instructions may be stored in the memory 44, which may be readable and/or readably connected to the processing circuitry 42. In other words, processing circuitry 42 may include a controller, which may comprise a microprocessor and/or microcontroller and/or FPGA (Field-Programmable Gate Array) device and/or ASIC (Application Specific Integrated Circuit) device. It may be considered that processing circuitry 42 includes or may be connected or connectable to memory, which may be configured to be accessible for reading and/or writing by the controller and/or processing circuitry 42.

The memory 44 is configured to store a pool of CSI-RS resource elements 50 which, in some embodiments, may be grouped in pairs of two resources to form a resource element as shown in FIG. 5. The wireless device 16 also includes a transceiver 48 configured to receive an indication of channel state information reference signals, CSI-RS, resources, the indication indicating one or more than one CSI-RS resources within a configured plurality of CSI-RS resources configured to be used by the wireless device 16 for CSI signaling. The transceiver 48 is further configured to perform CSI signaling on the at least one CSI resources.

FIG. 11 is a block diagram of an alternative embodiment of the wireless device 16 that can be implemented at least in part by software stored in memory and executable by a processor. A memory module 45 is configured to store a CSI-RS resource elements 50. The transceiver module 49 is configured to receive an indication of channel state information reference signals, CSI-RS, resources, the indication indicating one or more than one CSI-RS resources within a configured plurality of CSI-RS resources configured to be used by the wireless device 16 for CSI signaling. The transceiver 49 is further configured to perform CSI signaling on the at least one CSI resources.

Thus, in some embodiments, a network node 14 dynamically indicates to a wireless device 16 at least one CSI-RS resource element consisting of a pair of resources. This dynamic indication may be made by the DCI. The DCI may this be configured to trigger aperiodic reporting of CSI b the wireless device 16. In the alternative, in some embodiments, semi-persistent reporting by the wireless device 16 may be triggered via transmission of the indication of CSI-RS resource elements on a MAC-CE.

Whether a particular one of the CSI-RS resource elements is signaled to the wireless device 16 via DCI or a MAC-CE is determined according to a resource setting corresponding to at least one CSI-RS resource element. Resource settings may be stored in the memory 24 of the network node 14 and may specify whether a CSI-RS resource element is to be used by the wireless device 16 for aperiodic reporting or semi-persistent reporting of CSI. In some embodiments, the resource settings may specify how often the wireless device 16 is to report CSI, which resource elements to use and what codebook is to be used.

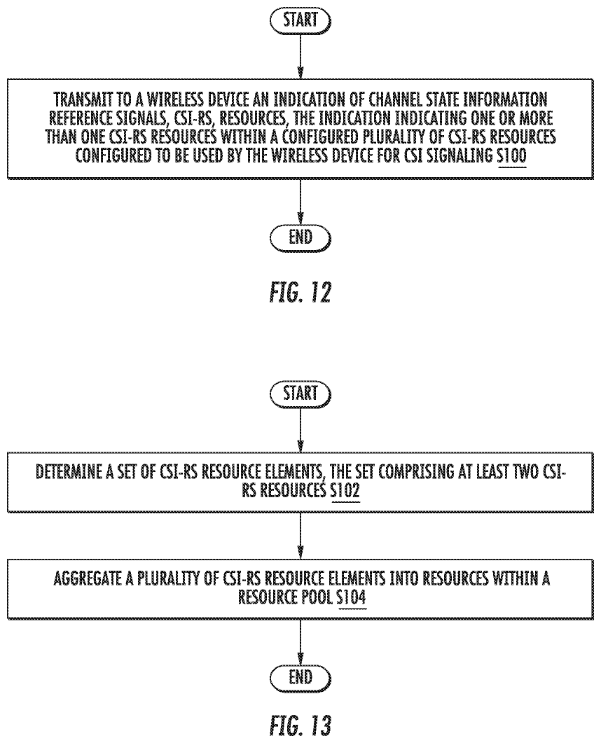

FIG. 12 is a flowchart of an exemplary process for providing an indication of CSI-RS resources to a wireless device 16. The process includes transmitting, via the transceiver 28, an indication of channel state information reference signals, CSI-RS, resources, the indication indicating one or more than one CSI-RS resources within a configured plurality of CSI-RS resources configured to be used by the wireless device 16 for CSI signaling (block S100).

FIG. 13 is a flowchart of an exemplary process for determining CSI-RS resource elements. The process includes determining, via the CSI-RS resource pool determination unit 18 a set of CSI-RS elements, the set comprising at least two CSI-RS resources (block S102). The process also includes aggregating, via the aggregation unit 20, a plurality of CSI-RS elements into resources within a resource pool (block S104).

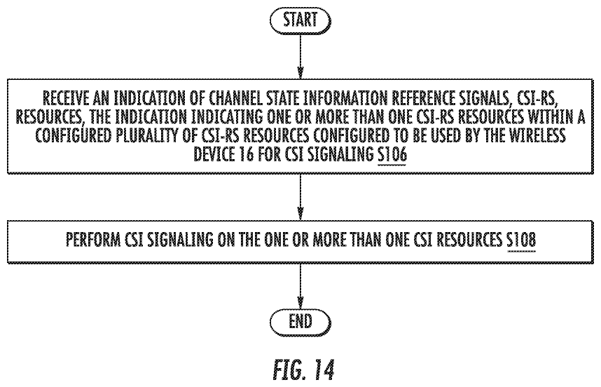

FIG. 14 is a flowchart of an exemplary process at a wireless device 16 of receiving CSI-RS resource indications. The process includes receiving, via the transceiver 48, an indication of channel state information reference signals, CSI-RS, resources, the indication indicating one or more than one CSI-RS resources within a configured plurality of CSI-RS resources configured to be used by the wireless device 16 for CSI signaling (block S106). The process also includes performing, via the transceiver 48, CSI signaling on the at least one CSI resources (block S108).

Thus, in some embodiments, a method at a network node 24 is provided, the method including transmitting to a wireless device 16 an indication of channel state information reference signals, CSI-RS, resources, the indication indicating one or more than one CSI-RS resource within a configured plurality of CSI-RS resources configured to be used by the wireless device 16 for CSI signaling S100.

In some embodiments, the plurality of CSI-RS resources configured to be used by the wireless device 16 for CSI signaling are configured through higher layers. In some embodiments, the indication is transmitted dynamically. In some embodiments, the indication is transmitted with one of downlink control information, DCI, and Medium Access Control Control Element, MAC CE signaling. In some embodiments, the indication indicates two temporally-successive orthogonal frequency division multiplex, OFDM, symbols, each of the two temporally-successive OFDM symbols being associated with at least one of two ports to form a resource element. In some embodiments, the indication indicates two successive frequency units forming one orthogonal frequency division multiplex, OFDM, symbol, each of the two frequency units being associated with at least one of two ports to form a resource element. In some embodiments, multiple different indications of different aggregations of resource elements are configured for the wireless device 16. In some embodiments, at least two different aggregations of resource elements share at least a pair of CSI-RS resources in common. In some embodiments, a number of resources sets are configured from a pool of N CSI-RS resources. In some embodiments, a report setting is based on resource settings applicable to a set of CSI-RS resources.

In some embodiments, a network node 14 is provided and includes a transceiver 28 configured to transmit to a wireless device 16 an indication of channel state information reference signals, CSI-RS, resources, the indication indicating one or more than one CSI-RS resource within a configured plurality of CSI-RS resources configured to be used by the wireless device 16 for CSI signaling.

In some embodiments, the plurality of CSI-RS resources configured to be used by the wireless device 16 for CSI signaling are configured through higher layers. In some embodiments, the indication is transmitted dynamically. In some embodiments, the indication is transmitted with one of downlink control information, DCI, and Medium Access Control Control Element, MAC CE signaling. In some embodiments, the indication indicates two temporally-successive orthogonal frequency division multiplex, OFDM, symbols, each of the two temporally-successive OFDM symbols being associated with at least one of two ports to form a resource element. In some embodiments, the indication indicates two successive frequency units forming one orthogonal frequency division multiplex, OFDM, symbol, each of the two frequency units being associated with at least one of two ports to form a resource element. In some embodiments, multiple different indications of different aggregations of resource elements are configured for the wireless device 16. In some embodiments, at least two different aggregations of resource elements share at least a pair of CSI-RS resources in common. In some embodiments, a number of resources set is configured from a pool of N CSI-RS resources. In some embodiments, a report setting is based on resource settings applicable to a set of CSI-RS resources.

In some embodiments, a network node 14 is provided and includes a transceiver module 29 configured to transmit to a wireless device 16 an indication of channel state information reference signals, CSI-RS, resources, the indication indicating one or more than one CSI-RS resource within a configured plurality of CSI-RS resources configured to be used by the wireless device 16 for CSI signaling.

In some embodiments, a method at a network node 14 of configuring channel state information reference signals, CSI-RS, is provided. The method includes determining a set of CSI-RS resource elements, the set comprising at least two CSI-RS resources S102. The method also includes aggregating a plurality of CSI-RS resource elements into resources within a resource pool S104.

In some embodiments, the plurality of CSI-RS resource elements configured to be used by the wireless device 16 for CSI signaling has been configured through higher layers. In some embodiments, the method further includes indicating an aggregation of CSI-RS resource elements to a wireless device 16. In some embodiments, the indicating is by dynamic signaling. In some embodiments, the indicating is by downlink control information, DCI. In some embodiments, the set of CSI-RS resource elements support a plurality of wireless devices 16 for cell-specific beam sweep whereby the wireless devices 16 measure a same beam. In some embodiments, different sets of CSI-RS resource elements are indicated to different wireless devices 16 to enable each of the different wireless devices 16 to measure a channel on a different beam.

In some embodiments, a network node 14 for configuring channel state information reference signals, CSI-RS, is provided. The network node 14 includes processing circuitry 22 configured to determine a set of CSI-RS resource elements, the set comprising at least two CSI-RS resources, and aggregate a plurality of CSI-RS resource elements into resources within a resource pool.

In some embodiments, the plurality of CSI-RS resource elements configured to be used by the wireless device 16 for CSI signaling have been configured through higher layers. In some embodiments, the processing circuitry 22 is further configured to indicate an aggregation of CSI-RS resource elements to a wireless device 16. In some embodiments, the indicating is by dynamic signaling. In some embodiments, the indicating is by downlink control information, DCI. In some embodiments, the set of CSI-RS elements support a plurality of wireless devices 16 for cell-specific beam sweep whereby the wireless devices 16 measure a same beam. In some embodiments, different sets of CSI-RS resource elements are indicated to different wireless devices 16 to enable each of the different wireless devices 16 to measure a channel on a different beam.

In some embodiments, a network node 14 for configuring channel state information reference signals, CSI-RS. The network node 14 includes a CSI-RS resource pool determination module 19 configured to determine a set of CSI-RS resource elements, the set comprising at least two CSI-RS resources. The network node 14 also includes an aggregation module 21 configured to aggregate a plurality of CSI-RS resource elements into resources within a resource pool.

In some embodiments, a method at a wireless device 16 includes receiving an indication of channel state information reference signals, CSI-RS, resources, the indication indicating one or more than one CSI-RS resources within a configured plurality of CSI-RS resources configured to be used by the wireless device 16 for CSI signaling S106. The method also includes performing CSI signaling on the at least one CSI resources S108.

In some embodiments, the indication indicates two temporally-successive orthogonal frequency division multiplex, OFDM, symbols, each of the two temporally-successive OFDM symbols being associated with at least one of two ports to form a resource element. In some embodiments, the indication indicates two successive frequency units forming one orthogonal frequency division multiplex, OFDM, symbol, each of the two frequency units being associated with at least one of two ports to form a resource element.

In some embodiments, a wireless device 16 includes a transceiver 48 configured to receive an indication of channel state information reference signals, CSI-RS, resources, the indication indicating one or more than one CSI-RS resources within a configured plurality of CSI-RS resources configured to be used by the wireless device 16 for CSI signaling, and perform CSI signaling on the at least one CSI resources.

In some embodiments, the indication indicates two temporally-successive orthogonal frequency division multiplex, OFDM, symbols, each of the two temporally-successive OFDM symbols being associated with at least one of two ports to form a resource element. In some embodiments, the indication indicates two successive frequency units forming one orthogonal frequency division multiplex, OFDM, symbol, each of the two frequency units being associated with at least one of two ports to form a resource element.

In some embodiments, a wireless device 16 includes a transceiver module 49 configured to receive an indication of channel state information reference signals, CSI-RS, resources, the indication indicating one or more than one CSI-RS resources within a configured plurality of CSI-RS resources configured to be used by the wireless device 16 for CSI signaling. The transceiver module 49 is configured to perform CSI signaling on the at least one CSI resources.

In some embodiments, a method at a base station 14 includes transmitting to a user equipment 16 an indication of channel state information reference signals, CSI-RS, resources, the indication indicating one or more than one CSI-RS resources within a configured plurality of CSI-RS resources configured to be used by the user equipment for CSI signaling S100.

In some embodiments, a base station 14 comprises a transceiver 28 configured to transmit to a user equipment 16 an indication of channel state information reference signals, CSI-RS, resources, the indication indicating one or more than one CSI-RS resource within a configured plurality of CSI-RS resources configured to be used by the user equipment 16 for CSI signaling.

In some embodiments, a method at a base station 14 of configuring channel state information reference signals, CSI-RS. The method includes determining a set of CSI-RS resource elements, the set comprising at least two CSI-RS resources S102. The method also includes aggregating a plurality of CSI-RS resource elements into resources within a resource pool S104.

In some embodiments, a base station 14 for configuring channel state information reference signals, CSI-RS. The base station 14 includes processing circuitry 22 configured to determine a set of CSI-RS resource elements, the set comprising at least two CSI-RS resources, and aggregate a plurality of CSI-RS resource elements into resources within a resource pool.

In some embodiments, a method at a user equipment 16 includes receiving an indication of channel state information reference signals, CSI-RS, resources, the indication indicating one or more than one CSI-RS resources within a configured plurality of CSI-RS resources configured to be used by the user equipment 16 for CSI signaling S106. The method includes performing CSI signaling on the at least one CSI resources.

In some embodiments, a user equipment 16 includes a transceiver 48 configured to receive an indication of channel state information reference signals, CSI-RS, resources, the indication indicating one or more than one CSI-RS resources within a configured plurality of CSI-RS resources configured to be used by the user equipment 16 for CSI signaling, and to perform CSI signaling on the at least one CSI resources.

Throughout the disclosure, “more than one” can be interpreted as “at least two” and vice-versa.

As will be appreciated by one of skill in the art, the concepts described herein may be embodied as a method, data processing system, and/or computer program product. Accordingly, the concepts described herein may take the form of an entirely hardware embodiment, an entirely software embodiment or an embodiment combining software and hardware aspects all generally referred to herein as a “circuit” or “module.” Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method at a network node, the method comprising:
dynamically transmitting to a wireless device an indication of channel state information reference signals, CSI-RS, resources, the indication indicating one or more than one CSI-RS resources within a configured plurality of CSI-RS resources configured to be used by the wireless device for CSI signaling.

2. The method of claim 1, wherein the plurality of CSI-RS resources configured to be used by the wireless device for CSI signaling are configured through higher layers.

3. (canceled)

4. The method of claim 1, wherein the indication is transmitted with one of downlink control information, DCI, and Medium Access Control Element, MAC CE signaling.

5. The method of claim 1, wherein the indication indicates two temporally-successive orthogonal frequency division multiplex, OFDM, symbols, each of the two temporally-successive OFDM symbols being associated with at least one of two ports to form a resource element.

6. The method of claim 1, wherein the indication indicates two successive frequency units forming one orthogonal frequency division multiplex, OFDM, symbol, each of the two frequency units being associated with at least one of two ports to form a resource element.

7. The method of any of claim 5, wherein multiple different indications of different aggregations of resource elements are configured for the wireless device.

8. The method of any of claim 5, wherein at least two different aggregations of resource elements share at least a pair of CSI-RS resources in common.

9. The method of claim 1, wherein a number of resources sets are configured from a pool of N CSI-RS resources.

10. The method of claim 1, wherein a report setting is based on resource settings applicable to a set of CSI-RS resources.

11. A network node, comprising:
a transceiver configured to dynamically transmit to a wireless device an indication of channel state information reference signals, CSI-RS, resources, the indication indicating one or more than one CSI-RS resource within a configured plurality of CSI-RS resources configured to be used by the wireless device for CSI signaling.

12. The network node of claim 11, wherein the plurality of CSI-RS resources configured to be used by the wireless device for CSI signaling are configured through higher layers.

13. (canceled)

14. The network node of claim 11, wherein the indication is transmitted with one of downlink control information, DCI, and Medium Access Control Element, MAC CE signaling.

15-18. (canceled)

19. The network node of claim 11, wherein a number of resources set is configured from a pool of N CSI-RS resources.

20. The network node of claim 11, wherein a report setting is based on resource settings applicable to a set of CSI-RS resources.

21-39. (canceled)

40. A wireless device comprising:
a transceiver configured to:
receive a dynamic indication of channel state information reference signals, CSI-RS, resources, the indication indicating one or more than one CSI-RS resources within a configured plurality of CSI-RS resources configured to be used by the wireless device for CSI signaling; and
perform CSI signaling on the at least one CSI resources.

41. The wireless device of claim 40, wherein the indication indicates two temporally-successive orthogonal frequency division multiplex, OFDM, symbols, each of the two temporally-successive OFDM symbols being associated with at least one of two ports to form a resource element.

42. The wireless device of claim 40, wherein the indication indicates two successive frequency units forming one orthogonal frequency division multiplex, OFDM, symbol, each of the two frequency units being associated with at least one of two ports to form a resource element.

43-49. (canceled)
